(19) United States
(12) Patent Application Publication
(10) Pub. No.: US 2024/0133755 A1
(43) Pub. Date: Apr. 25, 2024

(54) TEMPERATURE COEFFICIENT OF OFFSET COMPENSATION FOR FORCE SENSOR AND STRAIN GAUGE

(71) Applicant: NextInput, Inc., Mountain View, CA (US)

(72) Inventors: Julius Minglin Tsai, San Jose, CA (US); Dan Benjamin, Atlanta, GA (US)

(21) Appl. No.: 18/535,230

(22) Filed: Dec. 11, 2023

Related U.S. Application Data
(63) Continuation of application No. 18/103,465, filed on Jan. 30, 2023, now Pat. No. 11,898,918.
Application No. 18/103,465 is a continuation of application No. 16/757,225, filed on Apr. 17, 2020, now Pat. No. 11,579,028.
(60) Provisional application No. 62/573,271, filed on Oct. 17, 2017.

(51) Int. Cl. G01L 1/22; G01L 1/16; G01L 1/18

(52) U.S. Cl. CPC G01L 1/2281; G01L 1/16; G01L 1/18

(57) ABSTRACT

MEMS force sensors for providing temperature coefficient of offset (TCO) compensation are described herein. An example MEMS force sensor can include a TCO compensation layer to minimize the TCO of the force sensor. The bottom side of the force sensor can be electrically and mechanically mounted on a package substrate while the TCO compensation layer is disposed on the top side of the sensor. It is shown the TCO can be reduced to zero with the appropriate combination of Young's modulus, thickness, and/or thermal coefficient of expansion (TCE) of the TCO compensation layer.

### RELATED APPLICATIONS

This application is a continuation of U.S. patent application Ser. No. 18/103,465, filed Jan. 30, 2023, which is a continuation of U.S. patent application Ser. No. 16/757,225, filed Apr. 17, 2020, now U.S. Pat. No. 11,579,028, which is a 371 filing of International Application No. PCT/US2018/056245, filed Oct. 17, 2018, which claims the benefit of U.S. Provisional Application Ser. No. 62/573,271, filed Oct. 17, 2017, the disclosures of which are hereby incorporated herein by reference in their entireties.

### FIELD OF THE DISCLOSURE

The present disclosure relates to temperature coefficient of offset (TCO) compensation for force sensors and strain gauges in the chip scale package format.

### BACKGROUND

A MEMS force sensor or strain gauge has intrinsic offset as a result of the manufacturing and assembly processes. Additionally, the offset of the sensor can change in relation to temperature due to the thermal coefficient of expansion (TCE) mismatch between the package substrate, substrate of the sensor, solder bumps, and/or inter metal dielectric layers of the sensor chip. The slope of the offset versus temperature is defined as the temperature coefficient of offset (TCO). The offset under extreme temperatures can put subsequent amplifier and/or analog-to-digital convertor out of normal operation range and thus render the entire sensing system unusable.

In some conventional systems, the solution to TCO problems involve the electrical sensing circuitry, which broadens the operation range of the MEMS force sensor.

### SUMMARY

According to the present disclosure, a TCO compensation layer is provided on the MEMS force sensor to minimize the offset drift over temperature. By choosing the right combination of Young's modulus, thickness, and TCE, the TCO of the MEMS force sensor can be reduced to zero.

An example microelectromechanical (“MEMS”) force sensor for providing temperature coefficient of offset (TCO) compensation is described herein. The force sensor can include a sensor substrate configured to receive an applied force, where the sensor substrate can include a top surface and a bottom surface opposite thereto. The force sensor can also include a sensing element arranged on the bottom surface of the sensor substrate, where the sensing element is configured to convert a strain on the bottom surface of the sensor substrate to an electrical signal that is proportional to the strain. The force sensor can further include a compensation layer arranged on the top surface of the sensor substrate, where the compensation layer has a thermal coefficient of expansion that is different than a thermal coefficient of expansion of the sensor substrate.

Additionally, the thermal coefficient of expansion of the compensation layer can be less than the thermal coefficient of expansion of the sensor substrate. Alternatively, the thermal coefficient of expansion of the compensation layer can be greater than the thermal coefficient of expansion of the sensor substrate.

Alternatively or additionally, the thermal coefficient of expansion of the compensation layer can be within the same order of magnitude of a thermal coefficient of expansion of a package substrate.

Alternatively or additionally, at least one of a thickness of the compensation layer, a stiffness of the compensation layer, and/or the thermal coefficient of expansion of the compensation layer can minimize TCO. Optionally, a combination of a thickness, a stiffness, and the thermal coefficient of expansion of the compensation layer of the compensation layer can minimize TCO. Optionally, TCO is minimized at a value of about zero.

Alternatively or additionally, the MEMS force sensor can be configured for use as strain gauge.

Alternatively or additionally, the sensing element can be a piezoresistive sensing element.

Alternatively or additionally, the sensing element can be piezoresistive and piezoelectric elements.

Alternatively or additionally, the force sensor can further include a cap substrate, where the sensor and cap substrates are bonded together forming a sealed cavity there between.

Alternatively or additionally, the force sensor can be configured for electrical and mechanical coupling to a package substrate. In some implementations, the force sensor can be electrically and mechanically coupled to the package substrate. The package substrate can be a printed circuit board (PCB), a flexible printed circuit board (FPC), or a co-fired ceramic.

Alternatively or additionally, the compensation layer can be formed of at least one of polymer, polyimide, resin, polycarbonate, acrylonitrile butadiene styrene (ABS), silicon oxide, glass, or combinations thereof.

Alternatively or additionally, the force sensor can further include a plurality of sensing elements arranged on the bottom surface of the sensor substrate.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a MEMS force sensor using piezoresistive sensing element(s) with the TCO compensation layer. As shown in FIG. 1, the MEMS force sensor is mounted on a package substrate through solder bumps.

FIG. 2 illustrates a MEMS force sensor using both piezoresistive and piezoelectric sensing element(s) with the TCO compensation layer. As shown in FIG. 2, the MEMS force sensor is mounted on a package substrate through solder bumps.

FIG. 3 illustrates a MEMS force sensor having a sealed cavity and using piezoresistive sensing element(s) with the TCO compensation layer. As shown in FIG. 3, the MEMS force sensor is mounted on a package substrate through solder bumps.

FIG. 4 illustrates an exaggerated deformation due to a temperature increase from a zero stress condition.

FIG. 5 illustrates normalized TCO with fixed TCO compensation layer thickness and TCE versus the Young's modulus of the TCO compensation layer.

FIG. 6 illustrates normalized TCO with fixed TCO compensation layer Young's modulus and TCE versus the TCO compensation layer thickness.

### DETAILED DESCRIPTION

The present disclosure can be understood more readily by reference to the following detailed description, examples, drawings, and their previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching. To this end, those skilled in the relevant art will recognize and appreciate that many changes can be made, while still obtaining beneficial results. It will also be apparent that some of the desired benefits can be obtained by selecting some of the features without utilizing other features. Accordingly, those who work in the art will recognize that many modifications and adaptations may be possible and can even be desirable in certain circumstances, and are contemplated by this disclosure. Thus, the following description is provided as illustrative of the principles and not in limitation thereof.

As used throughout, the singular forms “a,” “an” and “the” include plural referents unless the context clearly dictates otherwise. Thus, for example, reference to “a force sensing element” can include two or more such force sensing elements unless the context indicates otherwise.

The term “comprising” and variations thereof as used herein is used synonymously with the term “including” and variations thereof and are open, non-limiting terms.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The present disclosure relates to the TCO compensation layer for MEMS force sensor and strain gauge. Three different types of MEMS force sensor's TCO can be compensated with this layer. The force sensor can also be reconfigured as strain gauge if the force is applied through the package substrate. The root cause of the TCO is illustrated and the material property and dimension effect to the TCO is also illustrated.

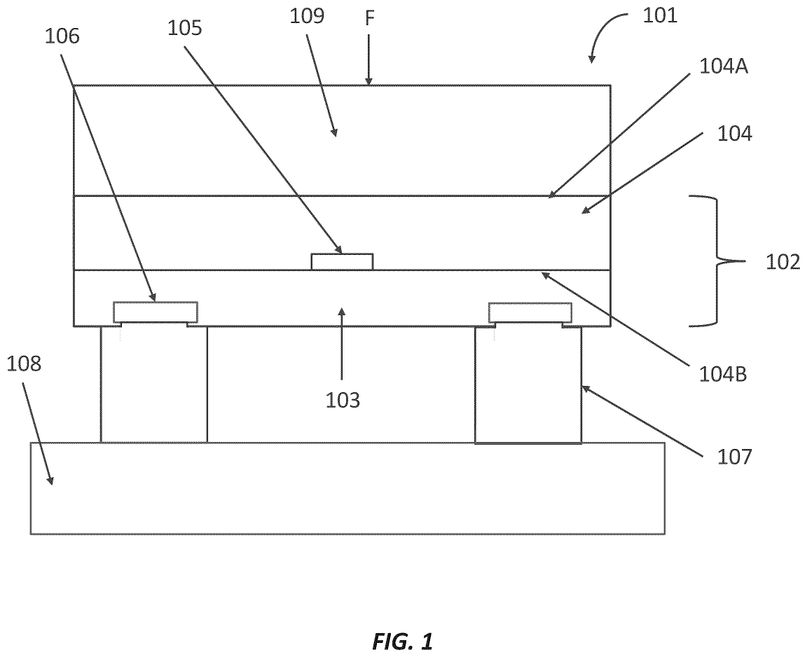

FIG. 1 illustrates the force sensor 102 (e.g., a MEMS force sensor) mounted on a package substrate 108. The package substrate 108 can be a printed circuit board (PCB), a flexible printed circuit board (FPC), or a co-fired ceramic. It should be understood that PCBs, FPCs, and co-fired ceramics are provided only as example package substrates. The combined force sensor and package substrate is shown by reference number 101 in FIG. 1. The force sensor 102 can include a dielectric layer 103, a sensor substrate 104, and a piezoresistive sensing element 105, The sensor substrate, which can also be referred to as a sensor die, can be made of a semiconductor material such as silicon or gallium arsenide, for example. As shown in FIG. 1, the sensor substrate 104 has a top surface 104A and a bottom surface 1048, which is opposite to the top surface 104A, The piezoresistive sensing element 105 is arranged on the bottom surface 1048. Optionally, in some implementations, a plurality of piezoresistive sensing elements 105 can be arranged on the sensor substrate 104. This disclosure contemplates that the piezoresistive sensing element(s) 105 can be diffused, deposited, or implanted on the bottom surface 104B. The dielectric layer 103 can then be arranged (e.g., deposited) over the bottom surface 104B to electrically isolate the piezoresistive sensing element(s) 105.

The piezoresistive sensing element 105 can change an electrical characteristic (e.g., resistance) in response to deflection of the sensor substrate 104. For example, the piezoresistive sensing element 105 can sense strain on the bottom surface 104A of the sensor substrate 104. The change in electrical characteristic can be measured as an analog electrical signal. In one implementation, the piezoresistive sensing element 105 can optionally be a piezoresistive transducer. For example, as strain is induced in the sensor substrate 104 proportional to a force “F” applied to the force sensor 102, a localized strain is produced on the piezoresistive transducer such that the piezoresistive transducer experiences compression or tension, depending on its specific orientation. As the piezoresistive transducer compresses and tenses, its resistivity changes in opposite fashion. Accordingly, a Wheatstone bridge circuit including a plurality (e.g., four) piezoresistive transducers (e.g., two of each orientation relative to strain) becomes unbalanced and produces a differential voltage (also sometimes referred to herein as an “analog electrical signal”) across the positive signal terminal and the negative signal terminal. This differential voltage is directly proportional to the applied force “F” on the force sensor 102. This differential voltage can be received at and processed by digital circuitry. For example, digital circuitry can be configured to, among other functions, convert the analog electrical signal to a digital electrical signal. Although piezoresistive transducers are provided as an example sensing element, this disclosure contemplates that the sensing element(s) can be any sensor element configured to change at least one electrical characteristic (e.g., resistance, charge, capacitance, etc.) based on an amount or magnitude of an applied force and can output a signal proportional to the amount or magnitude of the applied force. Other types of sensing elements include, but are not limited to, piezoelectric or capacitive sensors. Additionally, application of force “F” to the force sensor 102 is provided only as an example. This disclosure contemplates that force can be applied to other sides of the force sensor including, but not limited to, via the package substrate 108, which is arranged below the force sensor. Such application of force can produce a localized strain in the sensors. Example MEMS force sensors using piezoresistive sensing elements are described in U.S. Pat. No. 9,487,388, issued Nov. 8, 2016 and entitled “Ruggedized MEMS Force Die;” U.S. Pat. No. 9,493,342, issued Nov. 15, 2016 and entitled “Wafer Level MEMS Force Dies;” U.S. Pat. No. 9,902,611, issued Feb. 27, 2018 and entitled “Miniaturized and ruggedized wafer level mems force sensors;” and U.S. Patent Application Publication No. 2016/0363490 to Campbell et al., filed Jun. 10, 2016 and entitled “Ruggedized wafer level mems force sensor with a tolerance trench,” the disclosures of which are incorporated by reference in their entireties.

As shown in FIG. 1, the force sensor 102 can also include metal layer(s) 106. The metal layers 106 can be made of any suitable conductive material, including but not limited to, aluminum, copper, or gold, for example. The metal layers 106 can provide electrical connection between the force sensor 102 and the package substrate 108. For example, the force sensor 102 can be electrically and mechanically coupled to the package substrate 108 through solder bumps 107 provided on the bottom surface of the force sensor 102, The solder bumps 107 are connected to the force sensor 102 at the metal layers 106, which provide the electrical connection to the force sensor 102 such that an electrical signal can be transferred from the force sensor 102 to the package substrate 108. It should be understood that solder bumps 107 are provided in FIG. 1 only as an example mechanism for mechanically and electrically connecting the force sensor 102 to the package substrate 108.

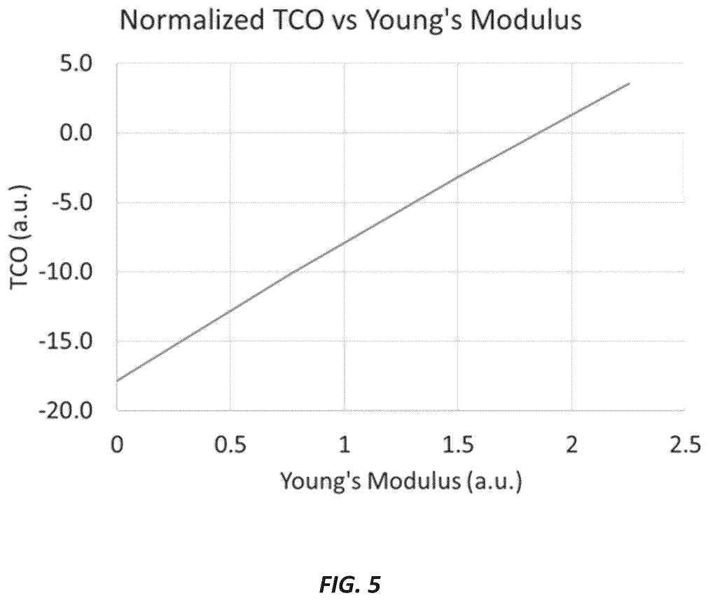

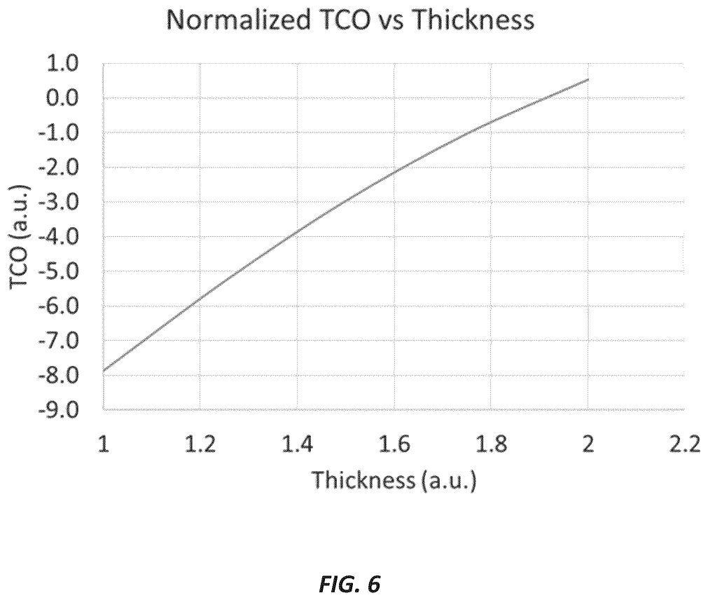

The force sensor 102 can also include a compensation layer 109 (also sometimes referred to herein as “TCO compensation layer”). The compensation layer 109 can be formed from materials including, but not limited to, polymer, polyimide, resin, polycarbonate, acrylonitrile butadiene styrene (ABS), silicon oxide, glass, or combinations thereof. As shown in FIG. 1, the TCO compensation layer 109 can be arranged on the top surface 104A of the sensor substrate 104. This disclosure contemplates that the force “F” can be applied to the force sensor 102 via the TCO compensation layer 109, e.g., the TCO compensation layer 109 can be disposed on the top surface of the force sensor. As described herein, the compensation layer 109 has a thermal coefficient of expansion (TCE) that is different than a TCE of the sensor substrate 104. In some implementations, the TCE of the compensation layer 109 can be less than the TCE of the sensor substrate 104. In other implementations, the TCE of the compensation layer 109 can be greater than the TCE of the sensor substrate 104. This disclosure contemplates that the thickness, the stiffness, the TCE, and/or the combination of thickness, stiffness, and TCE of the compensation layer 109 can be selected to reduce TCO. Alternatively or additionally, this disclosure contemplates that the thickness, the stiffness, the TCE, and/or the combination of thickness, stiffness, and TCE of the compensation layer 109 can be selected to minimize TCO. Optionally, the above characteristics of the compensation layer 109 can be selected to make TCO zero. Optionally, the above characteristics of the compensation layer 109 can be selected to make TCO a minimum but non-zero value based on design limitations (e.g., commercial, engineering, etc.). In other words, it should be understood that it may not be desirable or possible to reduce TCO to zero for every force sensor design. The effect of compensation layer stiffness on TCO is described below with regard to FIG. 5. The effect of compensation layer thickness on TCO is described below with regard to FIG. 6. Alternatively, as described above, the force “F” can be applied to the package substrate 108. In this implementation, the force “F” can be applied via a TCO compensation layer and the TCO compensation layer can be designed as described above.

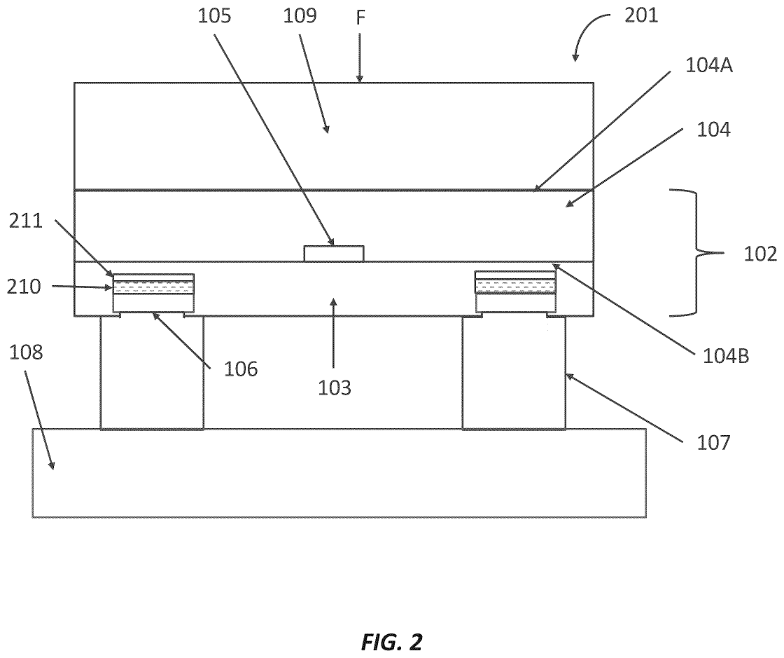

FIG. 2 illustrates the force sensor 102 (e.g., a MEMS force sensor) mounted on a package substrate 108. The package substrate 108 can be a printed circuit board (PCB), a flexible printed circuit board (FPC), or a co-fired ceramic. It should be understood that PCBs, FPCs, and co-fired ceramics are provided only as example package substrates. The combined force sensor and package substrate is shown by reference number 201 in FIG. 2. The force sensor 102 can include a dielectric layer 103, a sensor substrate 104, and a piezoresistive sensing element 105. The sensor substrate, which can also be referred to as a sensor die, can be made of a semiconductor material such as silicon or gallium arsenide, for example. As shown in FIG. 2, the sensor substrate 104 has a top surface 104A and a bottom surface 104B, which is opposite to the top surface 104A. The piezoresistive sensing element 105 is arranged on the bottom surface 104B. Optionally, in some implementations, a plurality of piezoresistive sensing elements 105 can be arranged on the sensor substrate 104. This disclosure contemplates that the piezoresistive sensing element(s) 105 can be diffused, deposited, or implanted on the bottom surface 104B. The dielectric layer 103 can then be arranged (e.g., deposited) over the bottom surface 104B to electrically isolate the piezoresistive sensing element(s) 105. Piezoresistive sensing elements are described above with regard to FIG. 1 and are therefore not described in further detail below.

As shown in FIG. 2, the force sensor 102 can include a piezoelectric sensor in addition to the piezoresistive sensing element(s) 105. This disclosure contemplates that the force sensor 102 can include a plurality of piezoelectric sensors. A piezoelectric sensor can include a piezoelectric sensing element 210 arranged between opposing electrodes. In FIG. 2, the piezoelectric sensing element 210 is sandwiched between piezoelectric electrode 211 and metal layer 106 (e.g., the opposing electrodes). Piezoresistive and piezoelectric sensing elements can be used together in MEMS force sensors. For example, piezoresistive sensing elements are useful for sensing static forces applied to the force sensor 102, while piezoelectric sensing elements are useful for sensing dynamic forces acting on the force sensor 102. Thus, both piezoresistive and piezoelectric sensors can be used in conjunction to detect both static and dynamic forces. As described above, the piezoelectric sensing element 210 is located between piezoelectric electrode 211 and metal layer 106. The piezoelectric sensing elements 105 can be configured to convert a change in strain to an analog electrical signal that is proportional to the change strain on the bottom surface 1043. The piezoelectric sensing elements 210 sense dynamic forces applied to the force sensor 102. Additionally, the electrical signals detected by the piezoresistive and piezoelectric sensing elements can be routed to digital circuitry. For example, the digital circuitry can be configured to, among other functions, convert the analog electrical signals to a digital electrical output signal. The use of both piezoresistive and piezoelectric sensing elements in a MEMS force sensor is described in detail in WO2018/148510, published Aug. 16, 2018 and entitled “INTEGRATED PIEZORESISTIVE AND PIEZOELECTRIC FUSION FORCE SENSOR,” the disclosure of which is expressly incorporated herein by reference in its entirety.

As shown in FIG. 2, the force sensor 102 can also include metal layer(s) 106. The metal layers 106 can be made of any suitable conductive material, including but not limited to, aluminum, copper, or gold, for example. The metal layers 106 can provide electrical connection between the force sensor 102 and the package substrate 108. For example, the force sensor 102 can be electrically and mechanically coupled to the package substrate 108 through solder bumps 107 provided on the bottom surface of the force sensor 102. The solder bumps 107 are connected to the force sensor 102 at the metal layer 106, which provides the electrical connection to the force sensor 102 such that an electrical signals can be transferred from the force sensor 102 to the package substrate 108. It should be understood that solder bumps 107 are provided in FIG. 2 only as an example mechanism for mechanically and electrically connecting the force sensor 102 to the package substrate 108.

The force sensor 102 can also include a compensation layer 109 (also sometimes referred to herein as “TCO compensation layer”). The compensation layer 109 can be formed from materials including, but not limited to, polymer, polyimide, resin, polycarbonate, acrylonitrile butadiene styrene (ABS), silicon oxide, glass, or combinations thereof. As shown in FIG. 2, the TCO compensation layer 109 can be arranged on the top surface 104A of the sensor substrate 104. This disclosure contemplates that the force “F” can be applied to the force sensor 102 via the TCO compensation layer 109, e.g., the TCO compensation layer 109 can be disposed on the top surface of the force sensor. As described herein, the compensation layer 109 has a thermal coefficient of expansion (TCE) that is different than a TCE of the sensor substrate 104. In some implementations, the TCE of the compensation layer 109 can be less than the TCE of the sensor substrate 104. In other implementations, the TCE of the compensation layer 109 can be greater than the TCE of the sensor substrate 104. This disclosure contemplates that the thickness, the stiffness, the TCE, and/or the combination of thickness, stiffness, and TCE of the compensation layer 109 can be selected to reduce TCO. Alternatively or additionally, this disclosure contemplates that the thickness, the stiffness, the TCE, and/or the combination of thickness, stiffness, and TCE of the compensation layer 109 can be selected to minimize TCO. Optionally, the above characteristics of the compensation layer 109 can be selected to make TCO zero. Optionally, the above characteristics of the compensation layer 109 can be selected to make TCO a minimum but non-zero value based on the design limitations (e.g., commercial, engineering, etc.). In other words, it should be understood that it may not be desirable or possible to reduce TCO to zero for every force sensor design. The effect of compensation layer thickness on TCO is described below with regard to FIG. 6. The effect of compensation layer stiffness on TCO is described below with regard to FIG. 5. Alternatively, as described above, the force “F” can be applied to the package substrate 108. In this implementation, the force “F” can be applied via a TCO compensation layer and the TCO compensation layer can be designed as described above.

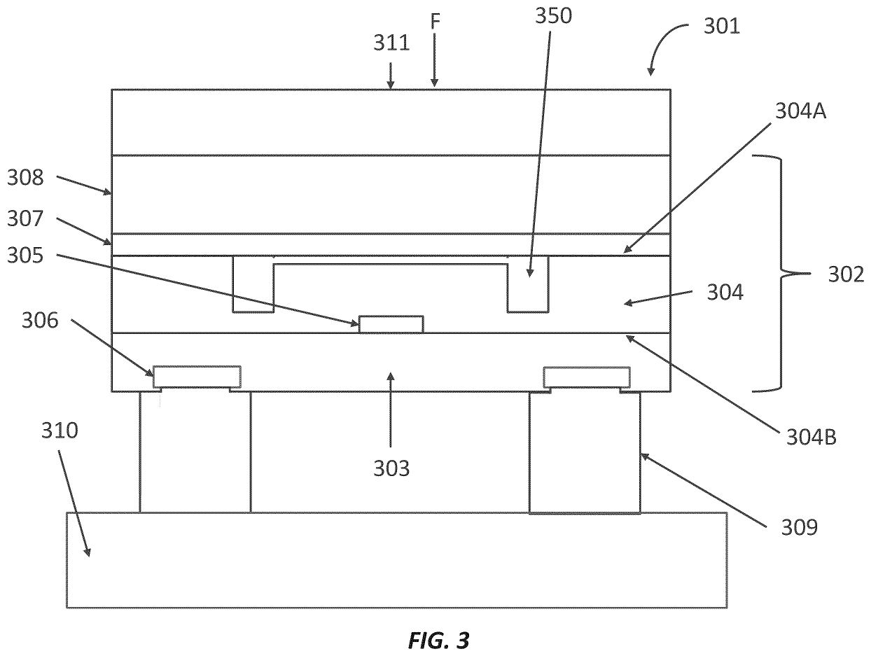

FIG. 3 illustrates another force sensor 302 (e.g., a MEMS force sensor) mounted on a package substrate 310. The package substrate 310 can be a printed circuit board (PCB), a flexible printed circuit board (FPC), or a co-fired ceramic. It should be understood that PCBs, FPCs, and co-fired ceramics are provided only as example package substrates. The combined force sensor and package substrate is shown by reference number 301 in FIG. 3. The force sensor 302 can include a dielectric layer 303, a sensor substrate 304, a bond oxide layer 307, a cap substrate 308, and a piezoresistive sensing element 305. The sensor substrate, which can also be referred to as a sensor die, can be made of a semiconductor material such as silicon or gallium arsenide, for example. As shown in FIG. 3, the sensor substrate 304 has a top surface 304A and a bottom surface 304B, which is opposite to the top surface 304A. The piezoresistive sensing element 305 is arranged on the bottom surface 304B. Optionally, in some implementations, a plurality of piezoresistive sensing elements 305 can be arranged on the sensor substrate 304. This disclosure contemplates that the piezoresistive sensing element(s) 305 can be diffused, deposited, or implanted on the bottom surface 304B. The dielectric layer 303 can then be arranged (e.g., deposited) over the bottom surface 304B to electrically isolate the piezoresistive sensing element(s) 305. Piezoresistive sensing elements are described above with regard to FIG. 1 and are therefore not described in further detail below.

As described above, the force sensor 302 can include the sensor substrate 304 and the cap substrate 308. The sensor substrate 304 and the cap substrate 308 can be bonded together via the bonded oxide layer 307. It should be understood that the bonded oxide layer 307 is only provided as an example mechanism for bonding the sensor substrate 304 and the cap substrate 308. For example, this disclosure contemplates bonding the substrates using other techniques known in the art including, but not limited to, silicon fusion bonding, anodic bonding, glass frit, thermo-compression, and eutectic bonding. The cap substrate 308 can optionally be made of glass (e.g., borosilicate glass) or semiconductor (e.g., silicon). The internal surfaces between the sensor substrate 304 and the cap substrate 308 form a sealed cavity 350. The sealed cavity 350 can be formed by etching a trench from the sensor substrate 304 and then sealing a volume between the bonded sensor substrate 304 and cap substrate 308. For example, the volume is sealed between the sensor substrate 304 and the cap substrate 308 when adhered together, which results in formation of the sealed cavity 350. Example MEMS force sensors having a sealed cavity are described in U.S. Pat. No. 9,902,611, issued Feb. 27, 2018 and entitled “Miniaturized and ruggedized wafer level mems force sensors;” and U.S. Patent Application Publication No. 2016/0363490 to Campbell et al., filed Jun. 10, 2016 and entitled “Ruggedized wafer level mems force sensor with a tolerance trench,” the disclosures of which are incorporated by reference in their entireties. The force sensor 302 therefore has a sealed cavity 350 that defines a volume entirely enclosed by the sensor substrate 304 and the cap substrate 308. The sealed cavity 350 can be sealed from the external environment.

As shown in FIG. 3, the force sensor 302 can also include metal layer(s) 306. The metal layers 306 can be made of any suitable conductive material, including but not limited to, aluminum, copper, or gold, for example. The metal layers 306 can provide electrical connection between the force sensor 302 and the package substrate 310. For example, the force sensor 302 can be electrically and mechanically coupled to the package substrate 310 through solder bumps 309 provided on the bottom surface of the force sensor 302. The solder bumps 309 are connected to the force sensor 302 at the metal layer 306, which provides the electrical connection to the force sensor 302 such that an electrical signal can be transferred from the force sensor 302 to the package substrate 310. It should be understood that solder bumps 309 are provided in FIG. 3 only as an example mechanism for mechanically and electrically connecting the force sensor 302 to the package substrate 310.

The force sensor 302 can also include a compensation layer 311 (also sometimes referred to herein as “TCO compensation layer”). The compensation layer 311 can be formed from materials including, but not limited to, polymer, polyimide, resin, polycarbonate, acrylonitrile butadiene styrene (ABS), silicon oxide, glass, or combinations thereof. As shown in FIG. 3, the TCO compensation layer 311 can be arranged on the top surface 304A of the sensor substrate 304. This disclosure contemplates that the force “F” can be applied to the force sensor 302 via the TCO compensation layer 311, e.g., the TCO compensation layer 311 can be disposed on the top surface of the force sensor. As described herein, the compensation layer 311 has a thermal coefficient of expansion (TCE) that is different than a TCE of the sensor substrate 304. In some implementations, the TCE of the compensation layer 311 can be less than the TCE of the sensor substrate 304. In other implementations, the TCE of the compensation layer 311 can be greater than the TCE of the sensor substrate 304. This disclosure contemplates that the thickness, the stiffness, the TCE, and/or the combination of thickness, stiffness, and TCE of the compensation layer 311 can be selected to reduce TCO. Alternatively or additionally, this disclosure contemplates that the thickness, the stiffness, the TCE, and/or the combination of thickness, stiffness, and TCE of the compensation layer 311 can be selected to minimize TCO. Optionally, the above characteristics of the compensation layer 311 can be selected to make TCO zero. Optionally, the above characteristics of the compensation layer 311 can be selected to make TCO a minimum but non-zero value based on the design limitations (e.g., commercial, engineering, etc.). In other words, it should be understood that it may not be desirable or possible to reduce TCO to zero for every force sensor design. The effect of compensation layer thickness on TCO is described below with regard to FIG. 6. The effect of compensation layer stiffness on TCO is described below with regard to FIG. 5. Alternatively, as described above, the force “F” can be applied to the package substrate 310. In this implementation, the force “F” can be applied via a TCO compensation layer and the TCO compensation layer can be designed as described above.

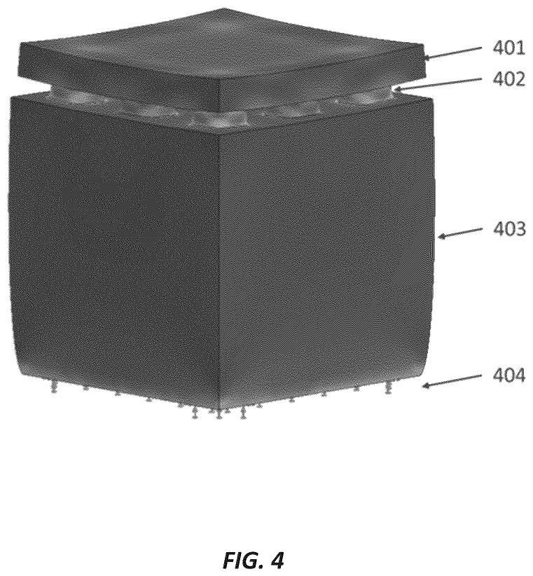

Referring now to FIG. 4, deformation of an example MEMS force sensor due to an increase in temperature is shown. Such deformation has been exaggerated by 5000 times to provide clear visual examination. In FIG. 4, a force sensor 401 is mounted to a package substrate 403 through solder bumps 402. It should be understood that the force sensor 401 can be similar to one of the force sensors shown in FIG. 1-3 with the exception of including a compensation layer (e.g., compensation layer 109 or 311 in FIGS. 1-3). In other words, the force sensor 401 can optionally include a sensor substrate, sensing element(s), a dielectric layer, and/or a cap substrate but does not include a TCO compensation layer. This disclosure contemplates that the bottom of the package substrate 404 is fixed for the purposes of the simulation, which mimics the actual operation conditions. In FIG. 4, a temperature raise (e.g., an increase in temperature) is applied to the model for simulation from zero stress condition for TCO simulation. As shown in FIG. 4, the package substrate 403 experiences thermal expansion as a result of the increase in temperature. Additionally, the deformation of the package substrate 403 is transferred to the force sensor 401 through the solder bumps 402. The deformation shown in FIG. 4 causes negative TCO. Although deformation causing negative TCO is shown in FIG. 4, this disclosure contemplates that deformation causing positive TCO can occur, for example, due to decreases in temperature.

Referring now to FIG. 5, a graph illustrating normalized TCO versus normalized Young's modulus for an example compensation layer is shown. In FIG. 5, TCO is normalized to the specific material and dimensions of an example MEMS force sensor. FIG. 5 illustrates the effect of varying the Young's modulus on TCO of the compensation layer. In the examples described herein, Young's modulus is provided as an example measure of the stiffness of the compensation layer material. Young's modulus is a known property that defines the relationship between stress and strain of a material. This disclosure contemplates that other measures of stiffness can be used. In some implementations, the TCE of the compensation layer is selected to be within the same order of magnitude of the TCE of the package substrate. In some implementations, the TCE of the compensation layer is selected to be about equal to the TCE of the package substrate. Optionally, the respective TCE of both the compensation layer and the package substrate can be larger than the TCE of silicon. As shown in FIG. 5, by increasing the Young's modulus of the compensation layer, the TCO increases linearly and proportionally to the Young's modulus of the compensation layer. Additionally, at a particular Young's modulus, the TCO crosses over from negative to positive value. In FIG. 5, this occurs where the normalized Young's modulus is about 2.0. Accordingly, by setting the Young's modulus appropriately, e.g., between about 1.5 to 2 for the example shown in FIG. 5, the TCO can be tuned to zero.

In some cases, neither the Young's modulus nor the TCE of the compensation layer can be chosen without limitation. This is because both the Young's modulus and TCE are material properties, and there may be limitations (e.g., commercial, engineering, etc.) on the materials used. As described below, the thickness of the compensation layer affects the TCO. Referring now to FIG. 6, a graph illustrating normalized TCO versus thickness of an example compensation layer is shown. In the example of FIG. 6, the Young's modulus and TCE are set based on the material of the compensation layer. FIG. 6 illustrates the relationship between the TCO and thickness of the compensation layer. At some value, the TCO crosses from negative to positive value. In FIG. 6, the TCO crosses over from negative to positive value around the normalized value of 1.9. Accordingly, by selecting a thickness of the compensation layer, the TCO can be reduced to zero at that specific thickness.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A microelectromechanical (“MEMS”) force sensor for providing temperature coefficient of offset (TCO) compensation, comprising:
a sensor substrate configured to receive an applied force;
a sensing element arranged on the sensor substrate, wherein the sensing element is configured to convert a strain on the sensor substrate to an electrical signal that is proportional to the strain; and
a compensation layer arranged on the sensor substrate, wherein the compensation layer has a thermal coefficient of expansion that is different than a thermal coefficient of expansion of the sensor substrate.

2. The MEMS force sensor of claim 1, wherein:
the sensor substrate comprises a first surface and a second surface;
the sensing element is arranged on the first surface of the sensor substrate;
the compensation layer is arranged on the second surface of the sensor substrate.

3. The MEMS force sensor of claim 1, wherein the first surface is a bottom surface of the sensor substrate.

4. The MEMS force sensor of claim 1, wherein the second surface is a top surface of the sensor substrate.

5. The MEMS force sensor of claim 1, wherein the first surface is oppositely disposed to the second surface.

6. The MEMS force sensor of claim 1, further comprising:
a package substrate; and
a solder bump that connects the sensor substrate to the package substrate.

7. The MEMS force sensor of claim 6, wherein:
the sensing element comprises a piezoelectric element; and
the piezoelectric element is sandwiched between the solder bump and the sensor substrate.

8. The MEMS force sensor of claim 1, wherein the thermal coefficient of expansion of the compensation layer is less than the thermal coefficient of expansion of the sensor substrate.

9. The MEMS force sensor of claim 1, wherein the thermal coefficient of expansion of the compensation layer is greater than the thermal coefficient of expansion of the sensor substrate.

10. The MEMS force sensor of claim 1, wherein the thermal coefficient of expansion of the compensation layer is within a same order of magnitude of a thermal coefficient of expansion of the package substrate.

11. The MEMS force sensor of claim 1, wherein a thickness of the compensation layer minimizes TCO.

12. The MEMS force sensor of claim 11, wherein the TCO is minimized at a value of about zero.

13. The MEMS force sensor of claim 1, wherein a stiffness of the compensation layer minimizes TCO.

14. The MEMS force sensor of claim 1, wherein the thermal coefficient of expansion of the compensation layer minimizes TCO.

15. The MEMS force sensor of claim 1, wherein a combination of a thickness, a stiffness, and the thermal coefficient of expansion of the compensation layer minimizes TCO.

16. The MEMS force sensor of claim 1, wherein the MEMS force sensor is configured for use as strain gauge.

17. The MEMS force sensor of claim 1, wherein the sensing element further comprises a piezoresistive sensing element.

18. The MEMS force sensor of claim 1, further comprising a cap substrate, wherein the sensor and cap substrates are bonded together forming a sealed cavity there between.

19. The MEMS force sensor of claim 1, wherein the MEMS force sensor is configured for electrical and mechanical coupling to the package substrate.

20. The MEMS force sensor of claim 1, wherein the MEMS force sensor is electrically and mechanically coupled to the package substrate, and wherein the package substrate is a printed circuit board (PCB).

21. The MEMS force sensor of claim 1, wherein the MEMS force sensor is electrically and mechanically coupled to the package substrate, and wherein the package substrate is a flexible printed circuit board (FPC).

22. The MEMS force sensor of claim 21, wherein the package substrate is a co-fired ceramic.

23. The MEMS force sensor of claim 1, wherein the compensation layer is formed of at least one of polymer, polyimide, resin, polycarbonate, acrylonitrile butadiene styrene (ABS), silicon oxide, glass, or combinations thereof.

24. The MEMS force sensor of claim 1, further comprising a plurality of sensing elements that includes the sensing element, wherein the plurality of sensing elements are arranged on the sensor substrate.
